(19) United States
(12) Patent Application Publication
(10) Pub. No.: US 2008/0252740 A1
(43) Pub. Date: Oct. 16, 2008

(54) Image Pickup Device and Encoded Data Transferring Method

(75) Inventor: Wang-Hyun Kim, Seoul (KR)

Correspondence Address: BIRCH STEWART KOLASCH & BIRCH, PO BOX 747, FALLS CHURCH, VA, 22040-0747, US

(73) Assignee: MTEKVISION CO., LTD., Seoul (KR)

(21) Appl. No.: 12/092,403

(22) PCT Filed: Oct. 24, 2006
(86) PCT No.: PCT/KR2006/004353

§ 371 Date: May 1, 2008

(30) Foreign Application Priority Data
Nov. 2, 2005 (KR) 10-2005-0104582

(51) Int. Cl. H04N 5/228

(52) U.S. Cl. 348/222.1; 348/E05.031

(57) ABSTRACT

A method of transferring encoded data and an imaging device executing the method thereof are disclosed. The image signal processor according to an embodiment of the present invention has an encoding unit and a data output unit, which temporarily stores image data encoded by the encoding unit and delivers the stored encoded image data to a receiving part. Here, the data output unit uses valid data only among the encoded image data to output an accumulated valid data column in units of a predetermine line size. Therefore, it becomes possible to increase the process efficiency of the back-end chip and to reduce the power consumption.

### TECHNICAL FIELD

The present invention is related to data encoding, more specifically to data encoding performed in an imaging device.

### BACKGROUND ART

By mounting a small or thin imaging device on a small or thin portable terminal, such as a portable phone or a PDA (personal digital assistant), the portable terminal can now function as an imaging device also. Thanks to this new development, the portable terminal, such as the portable phone, can send not only audio information but also visual information. The imaging device has been also mounted on a portable terminal such as the MP3 player, besides the portable phone and PDA. As a result, a variety of portable terminals can now function as an imaging device, capturing an external image and retaining the image as electronic data.

Generally, the imaging device uses a solid state imaging device such as a CCD (charge-couple device) image sensor or a CMOS (complementary metal-oxide semiconductor) image sensor.

FIG. 1 is a simplified structure of a typical imaging device, and FIG. 2 shows the steps of a typical JPEG encoding process. FIG. 3 shows signal types of a related image signal processor (ISP) for outputting encoded data.

As shown in FIG. 1, the imaging device, converting the captured external image to electronic data and displaying the image on a display unit 150, comprises an image sensor 110, an image signal processor (ISP) 120, a back-end chip 130, a baseband chip 140 and a display unit 150. The imaging device can further comprise a memory, for storing the converted electronic data, and an AD converter, converting an analog signal to a digital signal.

The image sensor 110 has a Bayer pattern and outputs an electrical signal, corresponding to the amount of light inputted through a lens, per unit pixel.

The image signal processor 120 converts raw data inputted from the image sensor 110 to a YUV value and outputs the converted YUV value to the back-end chip. Based on the fact that the human eye reacts more sensitively to luminance than to chrominance, the YUV method divides a color into a Y component, which is luminance, and U and V components, which are chrominance. Since the Y component is more sensitive to errors, more bits are coded in the Y component than in the U and V components. A typical Y:U:V ratio is 4:2:2.

By sequentially storing the converted YUV value in FIFO, the image signal processor 120 allows the back-end chip 130 to receive corresponding information.

The back-end chip 130 converts the inputted YUV value to JPEG or BMP through a predetermined encoding method and stores the YUV value in a memory, or decodes the encoded image, stored in the memory, to display on the display unit 150. The back-end chip 130 can also enlarge, reduce or rotate the image. Of course, it is possible, as shown in FIG. 1, that the baseband chip 140 can also receive from the back-end chip 130, and display on the display unit 150, the decoded data.

The baseband chip 140 controls the general operation of the imaging device. For example, once a command to capture an image is received from a user through a key input unit (not shown), the baseband chip 140 can make the back-end chip 130 generate encoded data corresponding to the inputted external image by sending an image generation command to the back-end chip 130.

The display unit 150 displays the decoded data, provided by the control of the back-end chip 130 or the baseband chip 140.

FIG. 2 illustrates the steps of typical JPEG encoding, carried out by the back-end chip 130. Since the JPEG encoding process 200 is well-known to those of ordinary skill in the art, only a brief description will be provided here.

As illustrated in FIG. 2, the image of the inputted YUV values is divided into a block in the size of 8×8 pixels, and in a step represented by 210, DCT (discrete cosine transform) is performed for each block. The pixel value, which is inputted as an 8-bit integer of between −129 and 127, is transformed to a value between −1024 and 1023 by DCT.

Then, in a step represented by 220, a quantizer quantizes a DCT coefficient of each block by applying a weighted value according to the effect on the visual. A table of this weighted value is called a “quantization table.” A quantization table value takes a small value near the DC and a high value at a high frequency, keeping the data loss low near the DC and compressing more data at a high frequency.

Then, in a step represented by 230, the final compressed data is generated by an entropy encoder, which is a lossless coder.

The data encoded through the above steps is stored in a memory. The back-end chip decodes the data loaded in the memory and displays the data on the display unit 150.

Signal types during the steps of sequentially inputting the data, stored in the memory, to process, for example, decoding are shown in FIG. 3. Generally, the back-end chip 130 is realized to receive the YUV/Bayer-format data, and the P_CLK, V_sync, H_REF and DATA signals are used as the interface for receiving this kind of data.

As shown in FIG. 3, the conventional back-end chip 130 maintains the output state of the clock signal (P_CLK) to an “On” state throughout the process of transferring the encoded data to a following element (e.g. a decoding unit), and thus the back-end chip 130 has to carry out an operation for interfacing with the following element while invalid data (e.g. data including 0x00) is inputted.

As a result, the back-end chip 130 of the conventional imaging device consumed unnecessary electric power by carrying out an unnecessary operation.

Moreover, as shown in FIG. 3, the conventional image signal processor 120 may output a new vertical synchronous signal (V_sync2) to the back-end chip 130 although the encoding process on the frame that is currently being processed is not completed.

In this case, the back-end chip 130 sometimes processes not only the frame that is currently being processed but also the next frame, not completing the input and/or process of correct data.

### DISCLOSURE

### Technical Problem

Therefore, the present invention provides a method of transferring encoded data and an imaging device executing the method thereof that can increase the process efficiency and reduce power consumption of the back-end chip.

The present invention also provides a method of transferring encoded data and an imaging device executing the method thereof that can increase the process efficiency and process speed of the back-end chip by having the encoded data, comprising only valid data making up the image, transmitted collectively to the back-end chip.

The present invention also provides a method of transferring encoded data and an imaging device executing the method thereof that can make the hardware design and control easier by using a general interface structure when the image signal processor provides encoded data to the back-end chip.

The present invention also provides a method of transferring encoded data and an imaging device executing the method thereof that can perform a smooth encoding operation by allowing the image signal processor to determine, in accordance with the encoding speed, whether the inputted frame is to be encoded.

Other objects of the present invention will become more apparent through the embodiments described below.

### Technical Solution

To achieve the above objects, an aspect of the present invention features an image signal processor and/or an imaging device having the image signal processor.

According to an embodiment of the present invention, the image signal processor of the imaging device has an encoding unit, which generates encoded image data by encoding in accordance with a predetermined encoding method image data corresponding to an electrical signal inputted from the image sensor, and a data output unit, which temporarily stores the image data encoded by the encoding unit and transfers the stored encoded image data to a receiving part. The data output unit can use valid data only among the encoded image data to accumulate in a valid data column, and can sequentially transmit to the receiving part the valid data column in units of a predetermined line size.

In case the number of transmissions of the valid data column is insufficient for a predetermined number of columns, the data output unit can repeatedly transmit to the receiving part a dummy data column corresponding to the line-size at every predetermined time interval until the insufficient number of columns is filled.

In case the size of the valid data column, including “STOP MARKER”, last transmitted to the receiving part among the valid data columns is insufficient for the line size, the data output unit can add dummy data until the size of the valid data column corresponds to the line size.

In case information for starting to input a following frame is inputted from the image sensor or the encoding unit while a preceding frame is processed by the encoding unit, the data output unit can input into the image sensor or the encoding unit a skip command to have the following frame skip the process.

The predetermined encoding method can be one of a JPEG encoding method, a BMP encoding method, an MPEG encoding method and a TV-out method.

The image signal processor can comprise a clock generator.

The data output unit can output a clock signal to the receiving part in a section only to which valid data is delivered.

The data output unit can further output a vertical synchronous signal (V_sync) and a valid data enable signal to the receiving part.

The data output unit can comprise a V_sync generator, which generates and outputs the vertical synchronous signal of high or low state in accordance with a vertical synchronous signal control command, an H_sync generator, which generates and outputs the valid data enable signal of high or low state in accordance with a valid data enable control command, a delay unit, which temporarily stores and accumulates in the valid data column the encoded data, outputs the valid data column in accordance with a data output command, generates dummy data in accordance with a dummy data generation command, and outputs a dummy data column corresponding to the line size, a calculation unit, which calculates the number of remaining transmissions by using a difference between the predetermined number of columns and one of the number of transmissions of the valid data enable signal of high or low state and the number of transmissions of the valid data column or the dummy data column, and a transmission control unit, which generates and outputs the vertical synchronous signal control command, the valid data enable control command, the dummy data generation command, and the data output command.

The transmission control unit can determine the number of transmissions of the dummy data column by making reference to the remaining number of transmissions upon termination of transmission of all valid data columns.

The transmission control unit can control the valid data enable signal to be outputted in an output section of the valid data column and an output section of the dummy data column only.

The valid data enable signal can be interpreted as a write enable signal in the receiving part.

The transmission control unit can determine, by using header information and tail information of the encoded image data stored in the delay unit, whether encoding of the preceding frame is completed.

In case input start information of the following frame is inputted while the preceding frame is being processed, the transmission control unit can control to maintain the current state if the vertical synchronous signal outputted by the V_sync generator is in a low state.

The image signal processor of the imaging device according to another embodiment of the present invention comprises a V_sync generator, which generates and outputs a vertical synchronous signal of high or low state in accordance with a vertical synchronous signal control command, an H_sync generator, which generates and outputs a valid data enable signal of high or low state in accordance with a valid data enable control command, a delay unit, which temporarily stores and accumulates in a valid data column encoded data, outputs the valid data column in accordance with a data output command, generates dummy data in accordance with a dummy data generation command, and outputs a dummy data column corresponding to a line size, a calculation unit, which calculates the number of remaining transmissions by using a difference between the predetermined number of columns and one of the number of transmissions of the valid data enable signal of high or low state and the number of transmissions of the valid data column or the dummy data column, and a transmission control unit, which generates and outputs the vertical synchronous signal control command, the valid data enable control command, the dummy data generation command, and the data output command.

The delay unit can use valid data only among the encoded image data to accumulate in a valid data column corresponding to a predetermined line size, and can output the accumulated valid data column, and the delay unit can repeatedly output, after all of the valid data columns are transmitted, a dummy data column corresponding to the line size at every predetermined time interval until the number of remaining transmissions becomes 0 (zero).

According to another embodiment of the present invention, in the imaging device, comprising an image sensor, an image signal processor, a back-end chip, and a baseband chip, the image signal processor comprises an encoding unit, which generates encoded image data by encoding in accordance with a predetermined encoding method image data corresponding to an electrical signal inputted from the image sensor, and a data output unit, which temporarily stores the image data encoded by the encoding unit and delivers the stored encoded image data to a receiving part. The receiving part includes a back-end chip or a baseband chip. The data output unit uses valid data only among the encoded image data to accumulate in a valid data column, and sequentially transmits to the receiving part the valid data column in units of a predetermined line size.

To achieve the above objects, another aspect of the present invention features a method of processing an image signal executed in the image signal processor and/or a recorded medium recording a program for executing the method thereof.

According to an embodiment of the present invention, the method of processing the image signal executed in the image signal processor of the imaging device comprises (a) storing image data encoded by an encoding unit and inputted sequentially, (b) accumulating a valid data column by using valid data only, and (c) outputting sequentially the accumulated valid data column in units of a predetermined line size to a receiving part.

The method can further comprise repeating the steps (a)-(c) on one frame, determining whether the number of transmissions of the valid data column is insufficient for a predetermined number of columns, in case all valid data columns on the frame are transmitted, and outputting repeatedly to the receiving part at every predetermined time interval a dummy data column corresponding to the line size until the number of remaining columns is satisfied, in case the number of transmissions of the valid data column is insufficient.

In case information for starting to input a following frame is inputted from the image sensor while a preceding frame is processed, the encoding process of the following frame can be controlled to be skipped.

Completion of encoding the preceding frame can be determined by using header information and tail information of the stored encoded image data.

In case the size of the valid data column, including “STOP MARKER”, last transmitted to the receiving part among the valid data columns is insufficient for the line size, the data output unit can add dummy data until the size of the valid data column corresponds to the line size.

A valid data enable signal can be outputted to the receiving part in only an output section of valid data among the stored encoded data.

The valid data enable signal can be interpreted as a write enable signal in the receiving part.

### DESCRIPTION OF DRAWINGS

FIG. 1 shows a simple structure of a typical imaging device;

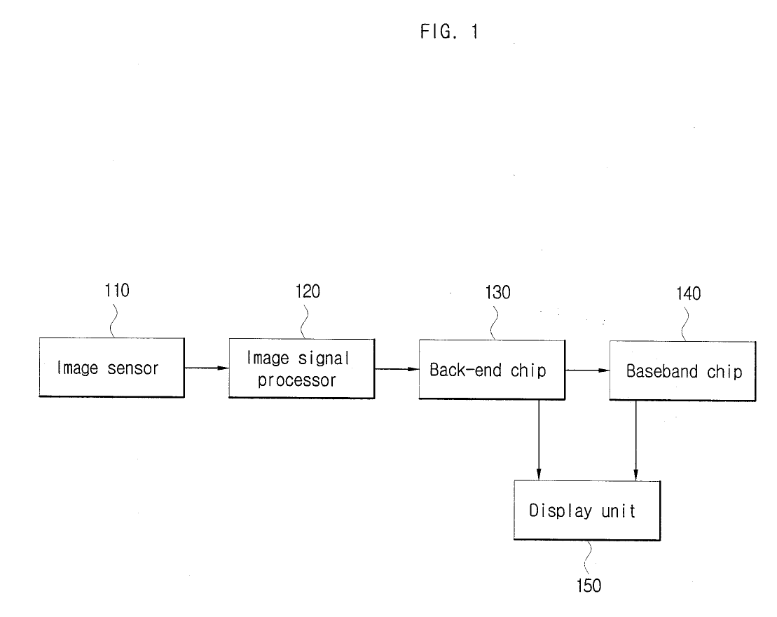

FIG. 2 shows the steps of typical JPEG encoding;

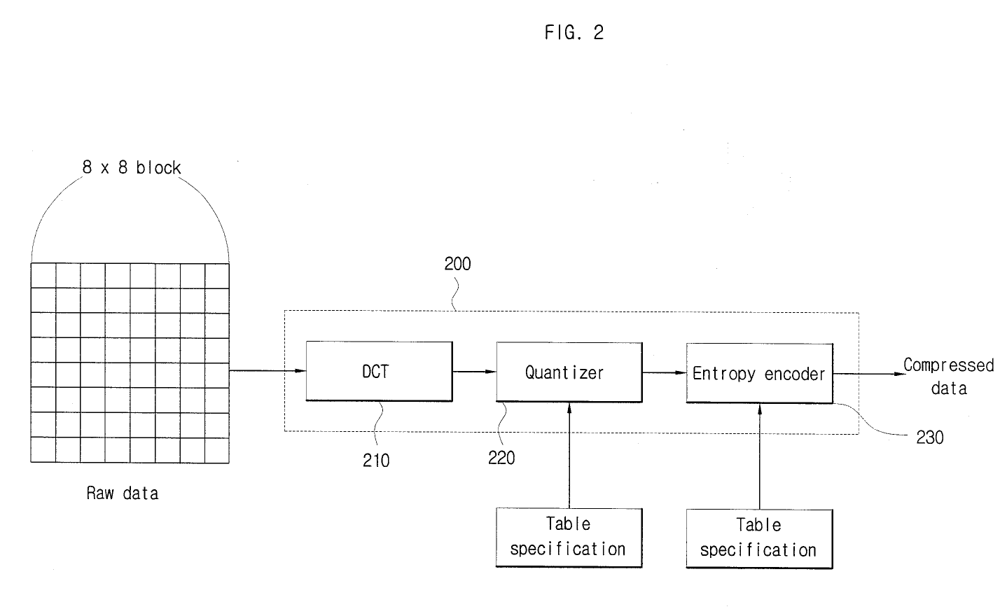

FIG. 3 shows signal types for which a conventional image signal processor outputs encoded data;

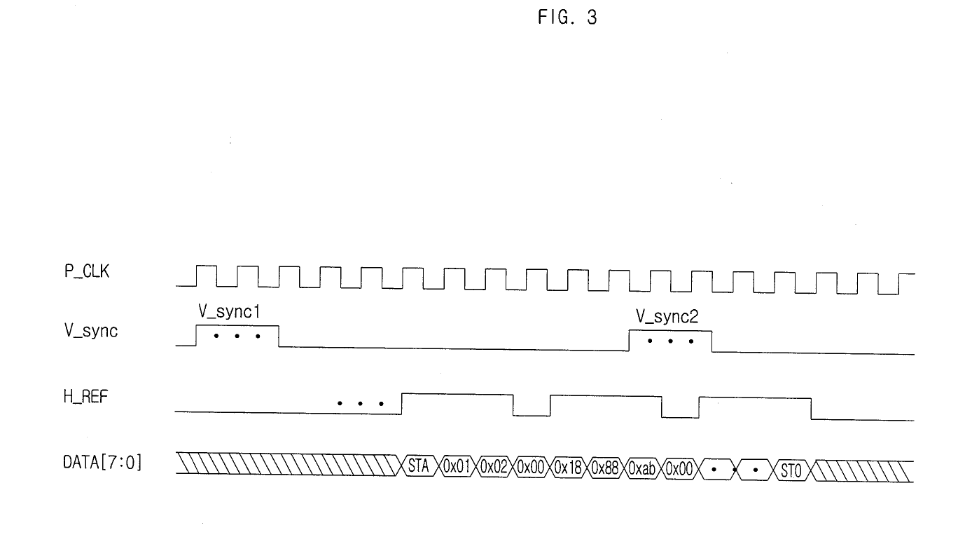

FIG. 4 shows the block diagram of an imaging device in accordance with an embodiment of the present invention;

FIG. 5 shows the block diagram of a data output unit in accordance with an embodiment of the present invention;

FIG. 6 shows the block diagram of a delay unit in accordance with an embodiment of the present invention;

FIG. 7 shows signal types for which an image signal processor outputs encoded data in accordance with an embodiment of the present invention;

FIG. 8 shows the conceptual diagram of how data, which are sent from the image signal processor and accumulated in the memory of a back-end chip, are stored in accordance with an embodiment of the present invention; and

FIG. 9 shows signal types for which the image signal processor outputs encoded data in accordance with another embodiment of the present invention.

### MODE FOR INVENTION

The above objects, features and advantages will become more apparent through the below description with reference to the accompanying drawings.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, preferred embodiments will be described in detail with reference to the accompanying drawings. Identical or corresponding elements will be given the same reference numerals, regardless of the figure number, and any redundant description of the identical or corresponding elements will not be repeated.

In describing the embodiments of the present invention, the process operation of the image signal processor, which is the core subject of the invention, will be described. However, it shall be evident that the scope of the present invention is by no means restricted by what is described herein.

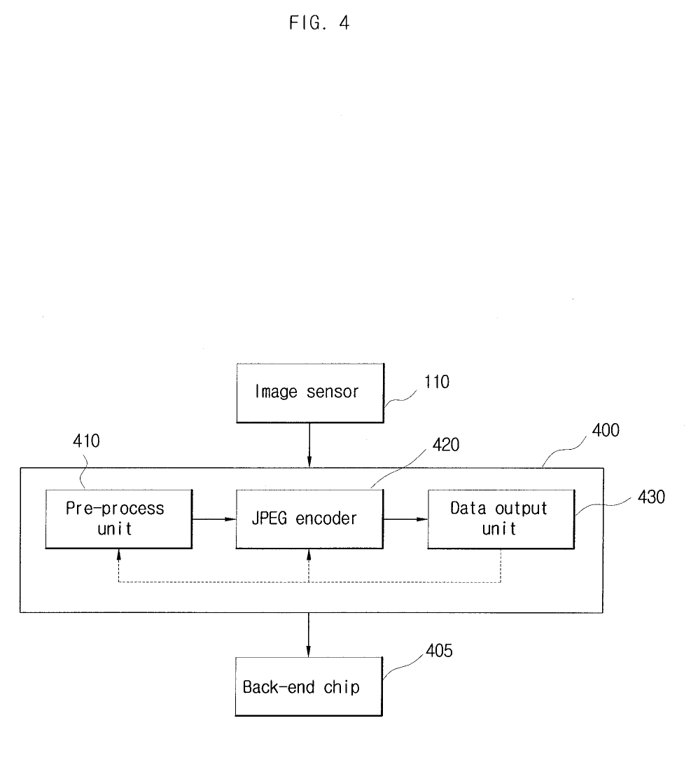

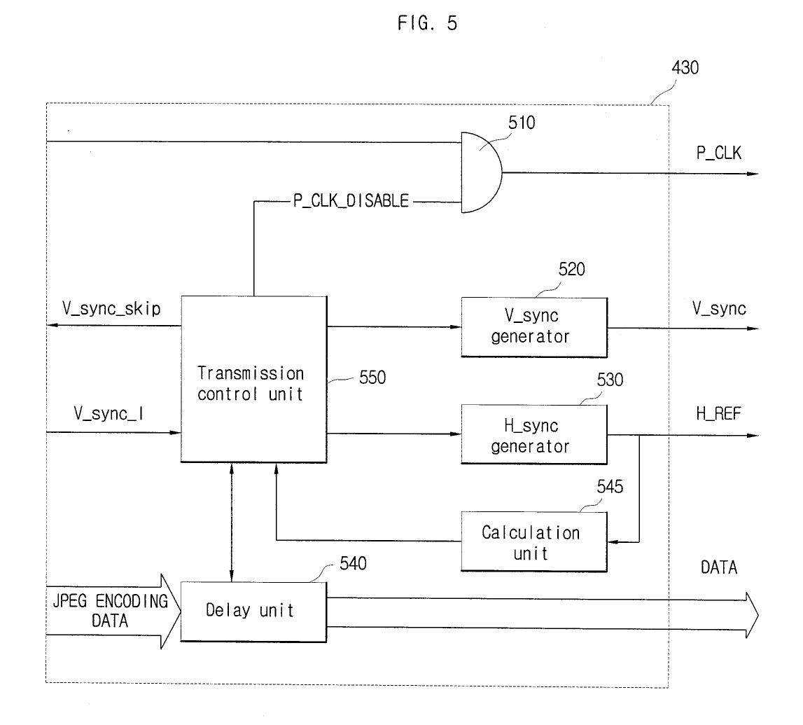

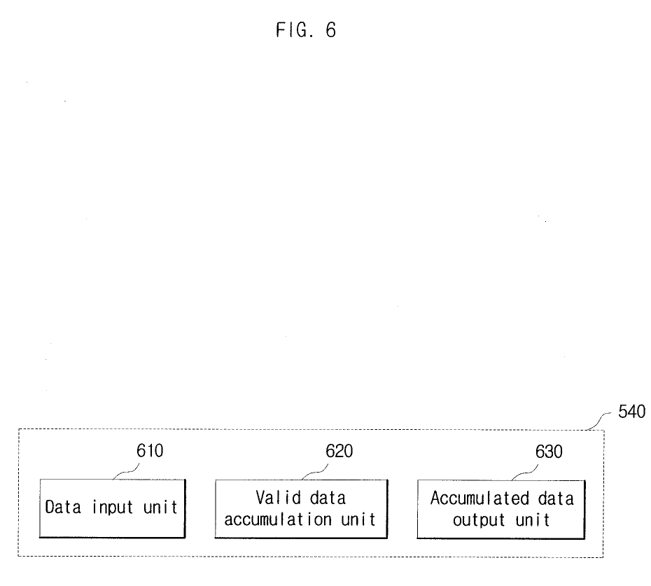

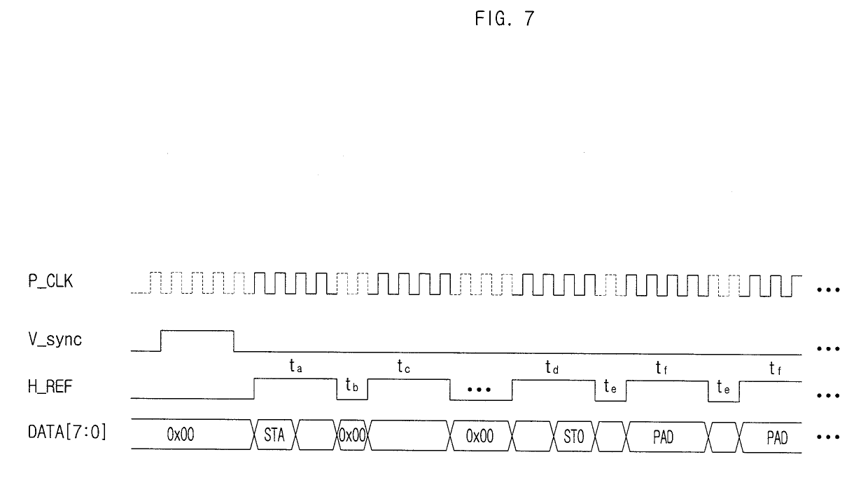

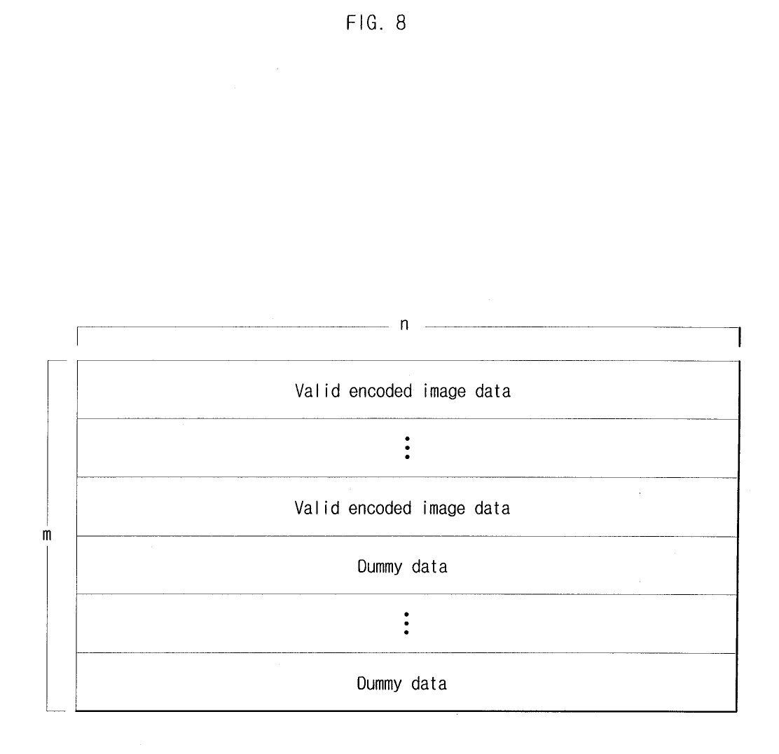

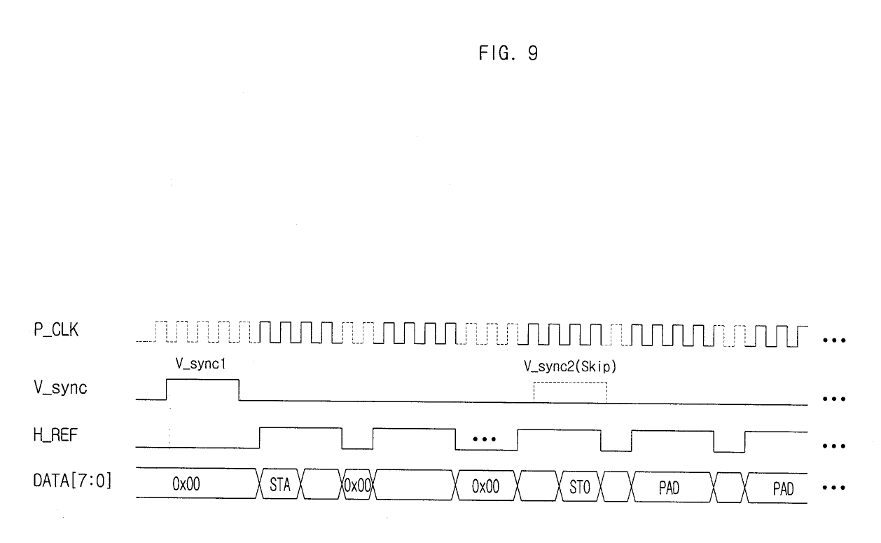

FIG. 4 shows the block diagram of an imaging device in accordance with an embodiment of the present invention; FIG. 5 shows the block diagram of a data output unit 430 in accordance with an embodiment of the present invention; FIG. 6 shows the block diagram of a delay unit 540 in accordance with an embodiment of the present invention; FIG. 7 shows signal types for which an image signal processor 400 outputs encoded data in accordance with an embodiment of the present invention; FIG. 8 shows the conceptional diagram of how data, which are sent from the image signal processor 400 and accumulated in the memory of a back-end chip 405, are stored in accordance with an embodiment of the present invention; and FIG. 9 shows signal types for which the image signal processor 400 outputs encoded data in accordance with another embodiment of the present invention.

As shown in FIG. 4, the imaging device can comprise an image sensor 110, an image signal processor 400 and a back-end chip 405. Although it is evident that the imaging device can further comprise a display unit 150, a memory, a baseband chip 140 and a key input unit, these elements are somewhat irrelevant to the present invention and hence will not be described herein.

The image signal processor 400 comprises a pre-process unit 410, a JPEG encoder 420 and a data output unit 430. The image signal processor 400 can of course further comprise a clock generator for internal operation.

The pre-process unit 410 performs pre-process steps in preparation for the process by the JPEG encoder 420. The pre-process unit 410 can receive from the image sensor 110 and process an electrical signal type of raw data for each frame per line, and then can transfer the raw data to the JPEG encoder 420.

The pre-process steps can comprise at least one of the steps consisting of color space transformation, filtering and color subsampling.

The color space transformation transforms an RGB color space to a YUV (or YIQ) color space. This is to reduce the amount of information without recognizing the difference in picture quality.

The filtering is a step of smoothing the image using a low-pass filter in order to increase the compression ratio.

The color subsampling subsamples the chrominance signal component by using all of the Y value, some of other values and none of the remaining values.

The JPEG encoder 420 compresses the pre-processed raw data, as in the method described earlier, and generates JPEG encoded data. The JPEG encoder 420 can comprise a memory for temporarily storing the processed raw data inputted from the pre-process unit 410 to divide the raw data into predetermined block units (e.g. 8×8) for encoding. In other words, the image signal processor 400 of the present invention can also encode image data, unlike the conventional image signal processor 120.

The data output unit 430 transfers the JPEG encoded data, generated by the JPEG encoder 420, to the back-end chip 420 (or a camera control processor, hereinafter referred to as “back-end chip” 405). When delivering the JPEG encoded data to the back-end chip 405, the data output unit 430 accumulates the data to a predetermined size.

The data in a predetermined size can comprise valid data only, valid data together with dummy data or dummy data only. For example, if the back-end chip 405 recognizes that a frame of 640×480 has received all JPEG encoded data, the data output unit 430 generates data corresponding to the line size of 640, using the data inputted from the JPEG encoder 420, and sends the generated data to the back-end chip 405. This will be sequentially repeated 480 times, which is the column size.

If the V_sync_I signal, which notifies the input on the following frame (e.g. (k+1)th inputted frame, hereinafter referred to as “(k+1)th frame”, whereas k is a natural number), is inputted from the image sensor 110 although the JPEG encoder 420 has not finished encoding a particular frame (e.g. the k^{th} inputted frame, hereinafter referred to as “k^{th} frame”), the data output unit 430 can control a V_sync generator 520 (refer to FIG. 5) to have the output of the V_sync signal corresponding to the frame skip.

The input of a new frame can be detected by various methods, including, for example, detecting a rising edge or falling edge of the V_sync signal, but the case of detecting the rising edge will be described here. In other words, if the V_sync generator 520 is outputting a low state of V_sync signal (i.e. no new frame is inputted) to the back-end chip 405, the data output unit 430 can control to maintain the current state (refer to V_sync2 illustrated with dotted lines in FIG. 9).

Of course, it is possible in this case that the data output unit 430 sends to the image sensor 110, the pre-process unit 410 or the JPEG encoder 420 a V_sync_skip signal for having the output and/or process skip on the (k+1)th frame corresponding to the V_sync_I signal.

Here, the image sensor 110, the pre-process unit 410 or the JPEG encoder 420 must have been already realized to carry out a predetermined operation when the V_sync_skip signal is received from the data output unit 430. The method for designing and realizing the above elements shall be easily understood through the present description by anyone skilled in the art, and hence will not be further described.

For example, in case the image sensor 110 received the V_sync skip signal, it is possible that the raw data of a frame corresponding to the V_sync_I signal is not sent to the pre-process unit 410. If the pre-process unit 410 received the V_sync_skip signal, it is possible that the process of the raw data of a frame corresponding to the V_sync_I signal is skipped or the processed raw data is not sent to the JPEG encoder 420. Likewise, if the JPEG encoder 420 received the V_sync_skip signal, it is possible that the processed raw data of a frame corresponding to the V_sync_I signal is not encoded or the processed raw data received from the pre-process unit 410 is not stored in the memory.

Through the above steps, although the raw data corresponding to frames #1, #2, #3 and #4 are sequentially inputted from the image sensor 110, the encoded image data inputted to the back-end chip 405 by the operation or control of the data output unit 430 can be restricted to #1, #3 and #4 only. That is, the process of the raw data corresponding to frame #2 may be skipped, or the storing step may be skipped although the process is not skipped.

For example, if a command to capture a picture is received from the baseband chip 140, which controls the general operation of the portable terminal, the back-end chip 405 receives and stores in the memory the picture-improved JPEG encoded data, which is inputted from the image signal processor 400, and then the back-end chip 405 decodes and displays on the display unit 150 the data, or the baseband chip 140 reads and processes the data.

The detailed structure of the data output unit 430 is illustrated in FIG. 5.

Referring to FIG. 5, the data output unit 430 can comprise an AND gate 510, the V_sync generator 520, an H_sync generator 530, the delay unit 540, a calculation unit 545 and a transmission control unit 550.

The AND gate 510 outputs a clock signal (P_CLK) to the back-end chip 405 only if every input is inputted with a signal. That is, by receiving the clock signal from a clock generator (not shown), disposed in the image signal processor 400, and receiving a clock control signal from the transmission control unit 550, the AND gate 510 outputs the clock signal to the back-end chip 405 only when the clock control signal instructs the output of the clock signal. The clock control signal can be a high signal or a low signal, each of which can be recognized as a P_CLK enable signal or a P_CLK disable signal.

The V_sync generator 520 generates and outputs the vertical synchronous signal (V_sync) for displaying a valid section, by the control of the transmission control unit 550. The V_sync generator 520 outputs a high state of V_sync signal until an output termination command of the V_sync signal is inputted by the transmission control unit 550 after an output command of the V_sync signal is inputted. It shall be evident to anyone skilled in the art that the vertical synchronous signal means the start of input of each frame.

The H_sync generator 530 generates and outputs a valid data enable signal (H_REF) by the control of the transmission control unit 550 (i.e. until an output termination command of H_REF is inputted after an output command of H_REF is inputted). The high section of the valid data enable signal coincides with the output section of data (i.e. valid data and/or dummy data) accumulated by a predetermined line size and outputted by the delay unit 540.

The delay unit 540 comprises a data input unit 610, a valid data accumulation unit 620 and an accumulated data output unit 630.

The data input unit 610 receives JPEG encoded data from the JPEG encoder 420. The data input unit 610 can also temporarily store JPEG encoded data inputted for the operation of the valid data accumulation unit 620. The data input unit 610 can comprise, for example, a register for delaying the data inputted from the JPEG encoder 420 for predetermined duration (e.g. 2-3 clocks) before outputting the data.

The valid data accumulation unit 620 extracts and accumulates the valid data (i.e. JPEG encoded data that actually forms an image) only among the JPEG encoded data that is inputted by the data input unit 610, and requests the transmission control unit 550 for a transmission instruction once the predetermined line size is accumulated. It is evident that whether the JPEG encoded data stored in the data input unit 610 or the valid data accumulation unit 620 is valid can be determined by the transmission control unit 550. In case the data stored in the data input unit 610 is used to determine the validity of the data, only the valid data will be present in the valid data accumulation unit 620.

Once the control command to transmit the accumulated data is inputted from the transmission control unit 550, the valid data accumulation unit 620 transmits the accumulated valid data to the back-end chip 405 through the accumulated data output unit 630. The line of valid data including “STOP MARKER,” which indicates the termination of JPEG encoding, may be accumulated short of the predetermined line size, in which case dummy data may be added to form the predetermined line size for transmission.

As described above, the delay unit 540 transmits accumulated valid data to the back-end chip 405 by the control of the transmission control unit 550. This will be repeated in accordance with a predetermined column size.

The delay unit 540 of the present invention excludes invalid data among the JPEG encoded data received from the JPEG encoder 420 and extracts valid data only to accumulate up to the predetermined line size, and thus can transmit all valid data on the k^{th} inputted frame to the back-end chip 405 prior to repeating in accordance with the predetermined column size. Invalid data, referred to in this invention, means data that is not valid (i.e. data that does not actually form an image) according to, for example, the JPEG standard, and is sometimes indicated as 0x00, for example.

In this case, the back-end chip 405 may recognize that the JPEG encoded data (and/or dummy data) of the predetermined line size×column size has not been received from the image signal processor 400 and may not carry out the process.

To prevent this, the image signal processor 400 generates dummy data (i.e. dummy data for filling up as much as the column size) and sends the dummy data to the back-end chip 405. For this, the valid data accumulation unit 620 can further execute a dummy data generation function. The generation of dummy data can be controlled to start when the transmission control unit 550 recognizes the information on the end of JPEG encoding by capturing “STOP MARKER” from the JPEG tail of valid data stored in the valid data accumulation unit 620. By this, the valid data accumulation unit 620 generates the predetermined size of dummy data and repeats the transmission of the dummy data by the number of remaining columns (i.e. the predetermined number of columns—the number of columns with valid data). Of course, it is possible that the transmission control unit 550 generates and provides to the valid data accumulation unit 620 the dummy data. It is also evidently possible that the dummy data can be pre-generated or pre-determined and that, if there is no valid data or insufficient amount of valid data when accumulating the predetermined column size of data, the insufficient amount of valid data can be substituted by the dummy data.

Once the data in the amount of a predetermined line size (n)×column size (m) are accumulated in the memory, the back-end chip 405 determines that all of the JPEG encoded data of the k^{th} frame are accumulated and starts the process. However, as shown in FIG. 8, the arrangement of the valid data among the data accumulated in the memory of the back-end chip 405 is concentrated in the front part, it can be possible to scan and process the valid data in a short time.

In case the JPEG encoder 420 includes an output memory for outputting encoded image data, the delay unit 540 can receive the encoded data from the output memory. By storing the JPEG encoded data in the memory, the back-end chip 405 allows the baseband chip 140 to use the data as necessary.

The calculation unit 545 counts the number of data transmission (i.e. the number of transmitted columns) hitherto by the delay unit 540 in accordance with the predetermined line size. Through this, how much more H_REF signals are to be generated and outputted to satisfy the predetermined column size for forming one frame is calculated, and the result is provided to the transmission control unit 550. FIG. 5 illustrates the case of the calculation unit 545 using the number of H_REF signals outputted by the H_sync generator 530 to calculate the number of remaining columns (i.e. the number of H_REF signal transmissions). According to the present invention, however, the section of the high state of H_REF and the output section of the valid/dummy data are identical, it shall be also possible to use the number of output sections of the valid/dummy data to calculate the number of remaining columns.

The transmission control unit 550 controls the output of the clock control signal, the V_sync generator 520, the H_sync generator 530 and the delay unit 540 to control the output state of each signal (i.e. P_CLK, H_sync, V_sync and data).

Moreover, the transmission control unit 550 controls the generation of the H_sync signal and dummy data in accordance with the number of remaining columns received from the calculation unit 545.

The transmission control unit 550 can recognize the information on the start and end of JPEG encoding by capturing “START MARKER” and “STOP MARKER” from the JPEG header and tail of the data stored in the delay unit 540. Through this, it becomes possible to recognize whether one frame is completely encoded by the JPEG encoder 420.

If the V_sync_I signal is inputted from the image sensor 110 although the JPEG encoding is not completed, the transmission control unit 550 controls the V_sync generator 520 to have the output of the V_sync signal skip, as shown in FIG. 9 and as described earlier. In other words, if the V_sync generator 520 is outputting the low state of V_sync signal to the back-end chip 405, the transmission control unit 550 will control to maintain the current state.

Then, as described earlier in detail, the transmission control unit 550 can control the following frame corresponding to the V_sync_skip signal to skip the output and process (e.g. JPEG encoding) of data by transmitting the V_sync_skip signal to the image sensor 110, the pre-process unit 410 or the JPEG encoder 420.

This is because the following element does not have to carry out any unnecessary process if data corresponding to the V_sync_I signal is not inputted from the preceding element (e.g. the image sensor 110 that received the V_sync_skip signal does not output raw data corresponding to the V_sync_I signal), or the following element can delete the inputted data (e.g. the JPEG encoder 420 that received the V_sync_skip signal does not encode but delete the processed raw data received from the pre-process unit 410 in accordance with the V_sync_I signal). Using this method, each element of the image signal processor 400 carries out its predetermined function but does not process the following frame unnecessarily, reducing unnecessary power consumption and limiting the reduction in process efficiency.

The signal types inputted to the back-end chip 405 by the control of the transmission control unit 550 are shown in FIG. 7.

As shown in FIG. 7, while invalid encoded data (0x00) is being outputted, the clock signal (P_CLK) to be outputted to the back-end chip 405 is turned off (the dotted sections of P_CLK in FIG. 7), and hence any unnecessary operation can be minimized, minimizing the power consumption of the back-end chip 405.

The sections (tₐ, t_{c}, t_{d}, t_{f}) in which the H_REF signal is outputted in the high state coincide with the output sections of the valid data or the dummy data (i.e. PAD).

In other words, after the V_sync signal is received, the data output unit 430 outputs a predetermined line size of valid data, which is accumulated in the valid data accumulation unit 620, during tₐ, and accumulates a predetermined line size of new valid data during t_{b}. Then, the accumulated valid data are outputted during t_{c}. After outputting all of the valid data, between “START MARKER” and “STOP MARKER”, of JPEG encoded data received from the JPEG encoder 420 by repeating the above steps, the dummy data are outputted during the repetitive t_{f} to fill the predetermined number of columns.

Here, since the predetermined line size of data are outputted during the duration for which the accumulated data are outputted, the duration coincides (i.e. tₐ=t_{c}=t_{d}=t_{f}). However, the duration for which the data are accumulated may not coincide. For example, the duration for accumulation will be shorter when the valid data are continuous than when the valid data are scattered. However, the duration for accumulating the dummy data (i.e. tₑ) will be identical. The duration for accumulating the dummy data can be predetermined, and the delay unit 540 can output the dummy data at every predetermined output point or by the control of the transmission control unit 550.

Although FIG. 7 illustrates as if only invalid data (e.g. data including 0x00) are outputted while the H_REF signal is low (e.g. t_{d}, tₑ), it shall be evident that actually other dummy data can be outputted.

Moreover, if the speed at which the JPEG encoder 420 encodes the image of the k^{th} frame, inputted from the image sensor 110, is slow (e.g. V_sync_I, indicating the start of input of a new frame, is inputted while encoding one frame), the data output unit 430 allows the JPEG encoding to be completed by having the V_sync signal for the following frame to be maintained low (i.e. the dotted sections of V_sync2, shown in FIG. 9; the V_sync2 signal, which would be outputted at the corresponding point in the related art, is skipped in the present invention), as shown in FIG. 9, since the following (k+1)th frame can not be simultaneously encoded (data error will occur if these frames are encoded simultaneously). By the control of the data output unit 430, the JPEG encoder 420 skips the encoding of the next frame. In case the transmission control unit 550 transmitted the V_sync_skip signal to the image sensor 110 or the pre-process unit 410, the JPEG encoder 420 may not be provided with data corresponding to V_sync_I from the preceding element.

The conventional back-end chip 405 is embodied to receive the YUV/Bayer format of data, and uses the P_CLK, V_sync, H_REF and DATA signals as the interface for receiving these data.

Considering this, the image signal processor 400 of the present invention is embodied to use the same interface as the conventional image signal processor.

Therefore, it shall be evident that the back-end chip 405 of the present invention can be port-matched although the back-end chip 405 is embodied through the conventional method of designing back-end chip.

For example, if the operation of a typical back-end chip 405 can be said to be initialized from an interrupt of the rising edge of the V_sync signal, the interfacing between the chips is possible, similar to outputting the conventional V_sync signal, in the present invention by inputting the corresponding signal to the back-end chip 405, since the conventional interface structure is identically applied to the present invention.

Likewise, considering that the typical back-end chip 405 must generate the V_sync rising interrupt and that the valid data enable signal (H_REF) is used as a write enable signal of the memory when data is received from the image signal processor 400, the power consumption of the back-end chip 405 can be reduced by using the signal output method of the present invention.

Hitherto, although the image signal processor 400 using the JPEG encoding method has been described, it shall be evident that the same data transmission method can be used for other encoding methods, such as the BMP encoding method, MPEG (MPEG 1/2/4 and MPEG-4 AVC) encoding and TV-out method.

The drawings and detailed description are only examples of the present invention, serve only for describing the present invention and by no means limit or restrict the spirit and scope of the present invention. Thus, any person of ordinary skill in the art shall understand that a large number of permutations and other equivalent embodiments are possible. The true scope of the present invention must be defined only by the spirit of the appended claims.

### INDUSTRIAL APPLICABILITY

As described above, the present invention can increase the process efficiency and reduce power consumption of the back-end chip.

The present invention can also increase the process efficiency and process speed of the back-end chip by having the encoded data, comprising only valid data making up the image, transmitted collectively to the back-end chip.

Moreover, the present invention can make the hardware design and control easier by using a general interface structure when the image signal processor provides encoded data to the back-end chip.

Furthermore, the present invention enables a smooth encoding operation by allowing the image signal processor to determine, in accordance with the encoding speed, whether the inputted frame is to be encoded.

1. An image signal processor of an imaging device, the image signal processor comprising:
an encoding unit, generating encoded image data by encoding, in accordance with a predetermined encoding method, image data corresponding to an electrical signal inputted from the image sensor; and
a data output unit, temporarily storing the image data encoded by the encoding unit and transferring the stored encoded image data to a receiving part,
whereas the data output unit uses valid data only among the encoded image data to accumulate in a valid data column, and sequentially transmits to the receiving part the valid data column in units of a predetermined line size.

2. The image signal processor of claim 1, wherein, in case the number of transmissions of the valid data column is insufficient for a predetermined number of columns, the data output unit repeatedly transmits to the receiving part a dummy data column corresponding to the line size at every predetermined time interval until the insufficient number of columns is filled.

3. The image signal processor of claim 1, wherein, in case the size of the valid data column, including “STOP MARKER”, last transmitted to the receiving part among the valid data columns is insufficient for the line size, the data output unit adds dummy data until the size of the valid data column corresponds to the line size.

4. The image signal processor of claim 1, wherein, in case information for starting to input a following frame is inputted from the image sensor or the encoding unit while a preceding frame is processed by the encoding unit, the data output unit inputs into the image sensor or the encoding unit a skip command to have the following frame skip the process.

5. The image signal processor of claim 1, wherein the predetermined encoding method is one of a JPEG encoding method, a BMP encoding method, an MPEG encoding method and a TV-out method.

6. The image signal processor of claim 1, further comprising a clock generator.

7. The image signal processor of claim 1, wherein the data output unit outputs a clock signal to the receiving part in a section only to which valid data is delivered.

8. The image signal processor of claim 1, wherein the data output unit further outputs a vertical synchronous signal (V_sync) and a valid data enable signal to the receiving part.

9. The image signal processor of claim 8, wherein the data output unit comprises:
a V_sync generator, generating and outputting the vertical synchronous signal of high or low state in accordance with a vertical synchronous signal control command;
an H_sync generator, generating and outputting the valid data enable signal of high or low state in accordance with a valid data enable control command;
a delay unit, temporarily storing and accumulating in the valid data column the encoded data, outputting the valid data column in accordance with a data output command, generating dummy data in accordance with a dummy data generation command, and outputting a dummy data column corresponding to the line size;
a calculation unit, calculating the number of remaining transmissions by using a difference between the predetermined number of columns and one of the number of transmissions of the valid data enable signal of high or low state and the number of transmissions of the valid data column or the dummy data column; and
a transmission control unit, generating and outputting the vertical synchronous signal control command, the valid data enable control command, the dummy data generation command, and the data output command.

10. The image signal processor of claim 9, wherein the transmission control unit determines the number of transmissions of the dummy data column by making reference to the remaining number of transmissions upon termination of transmission of all valid data columns.

11. The image signal processor of claim 9, wherein the transmission control unit controls the valid data enable signal to be outputted in an output section of the valid data column and an output section of the dummy data column only.

12. The image signal processor of claim 9, wherein the valid data enable signal is interpreted as a write enable signal in the receiving part.

13. The image signal processor of claim 9, wherein the transmission control unit determines, by using header information and tail information of the encoded image data stored in the delay unit, whether encoding of the preceding frame is completed.

14. The image signal processor of claim 13, wherein, in case input start information of the following frame is inputted while the preceding frame is being processed, the transmission control unit controls to maintain the current state if the vertical synchronous signal outputted by the V_sync generator is in a low state.

15. An image signal processor of an imaging device, the image signal processor comprising:
a V_sync generator, generating and outputting a vertical synchronous signal of high or low state in accordance with a vertical synchronous signal control command;
an H_sync generator, generating and outputting a valid data enable signal of high or low state in accordance with a valid data enable control command;
a delay unit, temporarily storing and accumulating in a valid data column encoded data, outputting the valid data column in accordance with a data output command, generating dummy data in accordance with a dummy data generation command, and outputting a dummy data column corresponding to a line size;
a calculation unit, calculating the number of remaining transmissions by using a difference between the predetermined number of columns and one of the number of transmissions of the valid data enable signal of high or low state and the number of transmissions of the valid data column or the dummy data column; and
a transmission control unit, generating and outputting the vertical synchronous signal control command, the valid data enable control command, the dummy data generation command, and the data output command.

16. The image signal processor of claim 15, wherein the delay unit uses valid data only among the encoded image data to accumulate in a valid data column corresponding to a predetermined line size, and outputs the accumulated valid data column,
and the delay unit repeatedly outputs, after all of the valid data columns are transmitted, a dummy data column corresponding to the line size at every predetermined time interval until the number of remaining transmissions becomes 0 (zero).

17. An imaging device, comprising an image sensor, an image signal processor, a back-end chip, and a baseband chip, wherein the image signal processor comprises:
an encoding unit, generating encoded image data by encoding, in accordance with a predetermined encoding method, image data corresponding to an electrical signal inputted from the image sensor; and
a data output unit, temporarily storing the image data encoded by the encoding unit and transferring the stored encoded image data to a receiving part,
whereas the data output unit uses valid data only among the encoded image data to accumulate in a valid data column, and sequentially transmits to the receiving part the valid data column in units of a predetermined line size.

18. A method of processing an image signal, the method executed in an image signal processor of an imaging device comprising an image sensor, the method comprising:
(a) storing image data, the image data being encoded by an encoding unit and being inputted sequentially;
(b) accumulating a valid data column by using valid data only;
(c) outputting sequentially the accumulated valid data column in units of a predetermined line size to a receiving part.

19. The method of claim 18, further comprising:
repeating the steps (a)-(c) for one frame;
determining whether the number of transmissions of the valid data column is insufficient for a predetermined number of columns, in case all valid data columns on the frame are transmitted; and
outputting repeatedly to the receiving part at every predetermined time interval a dummy data column corresponding to the line size until the number of remaining columns is satisfied, in case the number of transmissions of the valid data column is insufficient.

20. The method of claim 18, wherein, in case information for starting to input a following frame is inputted from the image sensor while a preceding frame is processed, the encoding process of the following frame is controlled to be skipped.

21. The method of claim 20, wherein completion of encoding the preceding frame is determined by using header information and tail information of the stored encoded image data.

22. The method of claim 18, wherein, in case the size of the valid data column, including “STOP MARKER”, last transmitted to the receiving part among the valid data columns is insufficient for the line size, the data output unit adds dummy data until the size of the valid data column corresponds to the line size.

23. The method of claim 18, wherein a valid data enable signal is outputted to the receiving part in only an output section of valid data among the stored encoded data.

24. The method of claim 23, wherein the valid data enable signal is interpreted as a write enable signal in the receiving part.
